(19) United States
(12) Patent Application Publication
(10) Pub. No.: US 2014/0013313 A1
(43) Pub. Date: Jan. 9, 2014

(54) Editor/Development Tool for Dataflow Programs

(71) Applicants: Johan Eker, Lund (SE); Harald GUSTAFSSON, Lund (SE); Carl Von PLATEN, Malmo (SE)

(72) Inventors: Johan Eker, Lund (SE); Harald GUSTAFSSON, Lund (SE); Carl Von PLATEN, Malmo (SE)

(21) Appl. No.: 13/541,110

(22) Filed: Jul. 3, 2012

(51) Int. Cl. G06F 9/44

(52) U.S. Cl. 717/132

(57) ABSTRACT

A dataflow source program is processed by a program development tool. Processing includes retrieving stored dataflow source program instructions from a memory. The tool ascertains a target model of computation (e.g., via an indicator embedded within the source program itself) to which the retrieved dataflow source program instructions are intended to conform. A dynamic behavior of the retrieved dataflow source program instructions is analyzed, and a compliance result is produced therefrom that includes an indication of whether the retrieved dataflow source program instructions conform to the target model of computation. The compliance result is then output to a user of the program development tool, so that it can inform and guide the improvement and further development of the program.

### BACKGROUND

The present invention relates to dataflow programming environments, and more particularly to editors and development tools for creating dataflow programs.

Dataflow modeling is emerging as a promising programming paradigm for streaming applications for multicore hardware and parallel platforms in general. This more constrained programming model benefits high-level transformations and facilitates advanced code optimizations and run-time scheduling.

A dataflow program is made up of a number of computational kernels, (called “actors” or “functional units”) and connections that specify the flow of data between the actors. An important property of a dataflow program is that the actors only interact by means of the flow of data over the connections: there is no other interaction. In particular, actors do not share state. The absence of shared state makes a dataflow program relatively easy to parallelize: the actors can execute in parallel, with each actors execution being constrained only by the requirement that all of its inputs be available.

FIG. 1 illustrates an exemplary graphical representation of a dataflow program 100 having seven actors, identified with respective reference numerals A, B, C, D, E, F, and G. The actors A, B, C, D, E, F, and G carry out their functions by means of their code (i.e., program instructions) being executed within a processing environment 101 that comprises one or more programmable processors 103 that retrieve program instructions and data from one or more non-transitory processor readable storage media (e.g., as represented by memory 105). Connections between the actors are indicated by arrows. The dataflow program 100 illustrates that an actor can have one or more input connections, and can have any number of output connections, including none. For example, actor G lacks any output ports, and is consequently commonly referred to as a “sink”. A sink does not affect the state of the other actors. In practice, sinks typically represent interaction with the environment in which the dataflow program executes. For example, a sink could represent an actuator, an output device, or the like. A sink could also represent a system that has not yet been implemented, in which case the sink mimics the missing subsystem's demand for input.

Feedback loops can be formed as illustrated in this example by actors C, D, E, and F forming a cycle, and also by actor B having a self-loop. It will be observed that feedback limits parallelism, since an actor's firing (i.e., its execution) may have to await the presence of input data derived from one of its earlier firings.

Communication between actors occurs asynchronously by means of the passing of so-called “tokens”, which are messages from one actor to another. These messages can represent any type of information (e.g., numeric, alphabetic, program-defined values, etc.), with the particular type of information in any one case being defined by the dataflow program. As used herein, the term “value” refers to the particular information (as distinguished from the information type or range of possible information instances) represented by a token or instance of an actor state without any limitation regarding whether that value is numeric, alphabetic, or other, and without regard to whether the information is or is not a complex data structure (e.g., a data structure comprising a plurality of members, each having its own associated value).

The dataflow programming model is a natural fit for many traditional Digital Signal Processing (DSP) applications such as, and without limitation, audio and video coding, image processing, embedded control, digital radio baseband algorithms, network processing, cryptography applications, and the like. Dataflow in this manner decouples the program specification from the available level of parallelism in the target hardware since the actual mapping of tasks onto threads, processes and cores is not done in the application code but instead in the compilation and deployment phase.

In a dataflow program, each actor's operation may consist of a number of actions, which are transformations of input data to output data, possibly involving state changes within the actor. The execution of an action is referred to as a firing and each firing is atomic with respect to each individual actor. The execution of a dataflow program is defined as a sequence of firings. Each action firing occurs as soon as all of its required input tokens become valid (i.e., are available) and, if one or more output tokens are produced from the actor, there is space available in corresponding output port buffers. Whether the firing of the action occurs as soon as it is instructed to do so or whether it must nonetheless wait for one or more other activities within the actor to conclude will depend on resource usage within the actor. Just as the firing of various actors within a dataflow program may be able to fire concurrently or alternatively may require some sort of sequential firing based on their relative data dependence on one another, the firing of various actions within an actor can either be performed concurrently or may alternatively require that some sequentiality be imposed based on whether the actions in question will be reading or writing the same resource; it is a requirement that only one action be able to read from or write to a resource during any action firing.

An input token that, either alone or in conjunction with others, instigates an action's firing is “consumed” as a result (i.e., it is removed from the incoming connection and ceases to be present at the actor's input port). An actor's actions can also be triggered by one or more state conditions, which include state variables combined with action trigger guard conditions and the action scheduler's finite state machine conditions. Guard conditions may be Boolean expressions that test any persistent state variable of the actor or its input token. (A persistent state variable of an actor may be modeled, or in some cases implemented, as the actor producing a token that it feeds back to one of its input ports.) One example (from among many) of a dataflow programming language is the CAL language that was developed at UC Berkeley The CAL language is described in “CAL Language Report: Specification of the CAL actor language, Johan Eker and Jörn W. Janneck, Technical Memorandum No. UCB/ERL M03/48, University of California, Berkeley, Calif., 94720, USA, Dec. 1, 2003”, which is hereby incorporated herein by reference in its entirety. In CAL, operations are represented by actors that may contain actions that read data from input ports (and thereby consume the data) and that produce data that is supplied to output ports. The CAL dataflow language has been selected as the formalism to be used in the new MPEG/RVC standard ISO/IEC 23001-4 or MPEG-B pt. 4. Similar programming models are also useful for implementing various functional components in mobile telecommunications networks.

Typically, the token passing between actors (and therefore also each connection from an actor output port to an actor input port) is modeled (but not necessarily implemented) as a First-In-First-Out (FIFO) buffer, such that an actor's output port that is sourcing a token pushes the token into a FIFO and an actor's input port that is to receive the token pops the token from the FIFO. An important characteristic of a FIFO (and therefore also of a connection between actor output and input ports) is that it preserves the order of the tokens contained therein; the reader of the FIFO receives the token in the same order in which that token was provided to the FIFO. Also, actors are typically able to test for the presence of tokens in a FIFO connected to one of the actor's input ports, and also to ascertain how many tokens are present in a FIFO, all without having to actually pop any tokens (and thereby remove the data from the FIFO).

The interested reader may refer to U.S. Pat. No. 7,761,272 to Janneck et al., which is hereby incorporated herein by reference in its entirety. The referenced document provides an overview of various aspects of dataflow program makeup and functionality.

Typical applications in the signal processing domain operate on data streams, which makes it convenient to specify such applications as dataflow programs. Other applications, however, require that data structures be shared between different parts of the application. Conventional implementations of dataflow programs include passing a data structure between actors by means of copying of the structure.

The inventors of the subject matter described herein have ascertained that naive implementations of dataflow programs tend to be burdened by high runtime overhead. This situation can be improved by analyzing and transforming the program before its deployment. To facilitate this analysis, a dataflow program is preferably implemented in a domain specific language, such as but not limited to the CAL dataflow language referenced above. These languages share a strict approach to how communication is handled (i.e., how tokens are consumed and produced). Different languages allow different levels of freedom regarding the dynamic behaviors of dataflow actors, and in particular with respect to the definable communication pattern of tokens. These communication patterns are commonly referred to as the “Model of Computation” (MoC) of the actor. Well-known MoC's include, but are not limited to:
Synchronous Dataflow (SDF)
Kahn Process Networks (KPN)
Cyclo-Static Dataflow (CSDF) (e.g., as defined in G. Bilsen et al., “Cyclo-static data flow”, IEEE Int. Conf. ASSP, pp. 3255-3258 (Detroit, Mich., May 1995))
Dynamic Dataflow (DN)

The inventors of the subject matter described herein have ascertained that it would be desirable to provide a mechanism that provides the dataflow program developer with feedback regarding the MoC associated with a written segment of code, including whether the segment of code adheres to a target MoC. It is also desired to provide such feedback in a user-interactive manner as the dataflow program is being created so that the program developer is guided when designing an actor/functional unit that is intended to conform to a target MoC.

### SUMMARY

It should be emphasized that the terms “comprises” and “comprising”, when used in this specification, are taken to specify the presence of stated features, integers, steps or components; but the use of these terms does not preclude the presence or addition of one or more other features, integers, steps, components or groups thereof.

In accordance with one aspect of the present invention, the foregoing and other objects are achieved in, for example, methods and apparatuses for processing a dataflow program by a program development tool. Such processing includes the program development tool retrieving stored dataflow source program instructions from a memory. A target model of computation to which the retrieved dataflow source program instructions are intended to conform is ascertained, and a dynamic behavior of the retrieved dataflow source program instructions is analyzed. A compliance result is produced from the analysis, wherein the compliance result includes an indication of whether the retrieved dataflow source program instructions conform to the target model of computation. The compliance result is then output to a user of the program development tool.

In some embodiments consistent with the invention, the compliance result includes an indication of which dataflow source program instruction or instructions is/are the reason for a failure of the retrieved dataflow source program instructions to conform to the target model of computation.

In some embodiments consistent with the invention, one or more of the retrieved dataflow source program instructions are displayed to the user of the program development tool, and outputting the compliance result to the user of the program development tool comprises displaying one or more graphic indicators of noncompliance in-line with one or more displayed dataflow source program instructions.

In some embodiments consistent with the invention, processing the dataflow program includes modifying the retrieved dataflow source program instructions based on information supplied to the program development tool by the user of the program development tool.

In some embodiments consistent with the invention, ascertaining the target model of computation to which the retrieved dataflow source program instructions are intended to conform comprises retrieving a portion of the stored dataflow source program instructions that includes an indicator of the target model of computation. In some of these embodiments, the indicator of the target model of computation includes a keyword embedded in a comment line of the dataflow source program instructions.

In some embodiments consistent with the invention, ascertaining the target model of computation to which the retrieved dataflow source program instructions are intended to conform comprises using an interactive program development tool interface to receive an indicator of the target model of computation from the user of the program development tool.

In some embodiments consistent with the invention, ascertaining the target model of computation to which the retrieved dataflow source program instructions are intended to conform comprises receiving an indicator of the target model of computation from a stored project settings portion of the dataflow program development tool.

### BRIEF DESCRIPTION OF THE DRAWINGS

FIG. 1 illustrates an exemplary graphical representation of a dataflow program having seven actors.

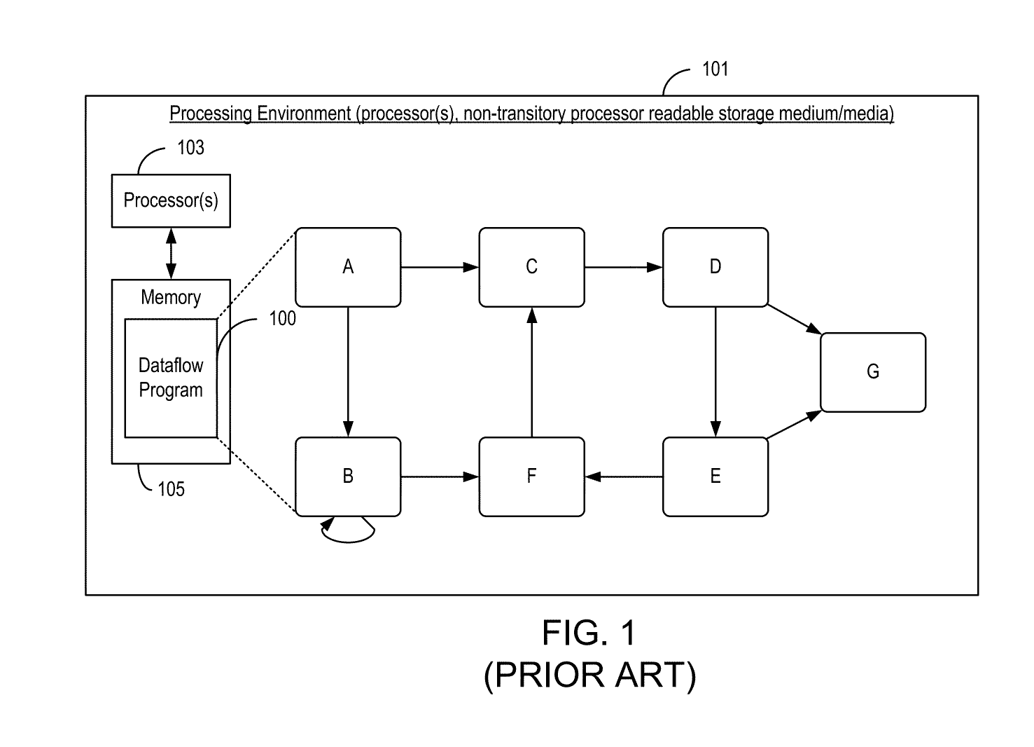

FIG. 2 shows an exemplary finite state machine illustrating a representation of action selection in a dataflow program, with transitions from one state to another corresponding to action firings.

FIG. 3 is an exemplary development tool graphical user interface that provides informational feedback to a user in accordance with some aspects of embodiments consistent with the invention.

FIG. 4 is, in one respect, a flow chart of steps/processes performed by a dataflow program development tool in accordance with some but not necessarily all exemplary embodiments of the invention.

FIG. 5 is a block diagram showing an overall exemplary embodiment of a processing environment that includes a dataflow program development tool that provides informational feedback to the user with respect to source code compliance with a target model of computation.

### DETAILED DESCRIPTION

The various features of the invention will now be described with reference to the figures, in which like parts are identified with the same reference characters.

The various aspects of the invention will now be described in greater detail in connection with a number of exemplary embodiments. To facilitate an understanding of the invention, many aspects of the invention are described in terms of sequences of actions to be performed by elements of a computer system or other hardware capable of executing programmed instructions. It will be recognized that in each of the embodiments, the various actions could be performed by specialized circuits (e.g., analog and/or discrete logic gates interconnected to perform a specialized function), by one or more processors programmed with a suitable set of instructions, or by a combination of both. The term “circuitry configured to” perform one or more described actions is used herein to refer to any such embodiment (i.e., one or more specialized circuits and/or one or more programmed processors). Moreover, the invention can additionally be considered to be embodied entirely within any form of computer readable carrier, such as solid-state memory, magnetic disk, or optical disk containing an appropriate set of computer instructions that would cause a processor to carry out the techniques described herein. Thus, the various aspects of the invention may be embodied in many different forms, and all such forms are contemplated to be within the scope of the invention. For each of the various aspects of the invention, any such form of embodiments as described above may be referred to herein as “logic configured to” perform a described action, or alternatively as “logic that” performs a described action.

As mentioned in the Background section, dataflow programming techniques are being exploited in the development of a wide range of software applications because of the benefits to be obtained with respect to high-level transformations and the facilitation of advanced code optimizations and run-time scheduling. However, in many instances the programming languages and tools that have been used for software development are overly restrictive, supporting only one particular MoC and thus not giving the developer enough expressive power to implement real-world applications.

At the other extreme, many conventional algorithms are implemented either using plain C and assembler or Unified Modeling Language (UML) tools, such as Rose Realtime. While these approaches commonly can be categorized as following a dataflow paradigm, they offer little or no possibility for automatic analysis with respect to scheduling due to the high degrees of freedom in the source representation. This prohibits high-level optimizations and analysis.

These problems can be overcome by using a more constrained programming language. In designing development tools, there is commonly a trade-off between analyzability and expressiveness: restricting expressiveness enhances analyzability. However, for many real-world applications, more expressive specification languages are needed for efficient implementations. This expressiveness is commonly only needed for parts of the dataflow program, however. If the software developer were to write code that complied with the requirements of a given class of MoC, it would be possible to apply the well-known dataflow theory referenced above to subsets of the program. However, a major obstacle in achieving this has been the difficulty associated with manually writing code that can be automatically categorized.

Therefore, aspects of embodiments consistent with the invention involve allowing the software developer to have a high level of freedom with respect to expressiveness, but to provide automated guidance to facilitate the developer's writing code that can be automatically analyzed.

In another aspect, guidance is provided in the form of a software development tool that, in one respect, operates as a source code editor and, in another respect, receives input from the user that indicates a target MoC that the source code is intended to conform to and outputs to the user an indication of whether the written source actually conforms to the target MoC. In yet another aspect of some embodiments, the development tool outputs to the user one or more suggestions indicating what changes to make to the source code to transform it into code that does conform to the target MoC.

These and other aspects will now be further described in the following.

In order to be able to provide the software developer with the informational feedback and guidance mentioned above, the dataflow program development tool includes a classifier. Actor classification has the purpose of identifying actors that adhere to particular restrictions (such as those of SDF and CSDF). Additional properties, particularly the rates at which an actor consumes and produces tokens, are computed as a side-effect.

The actor classifier works by analyzing the internal behavior of each actor in isolation. The following properties are determined:
Classification of the actor: “static” or “dynamic”
Whether the actor executes indefinitely or whether has the possibility of terminating
In the case of a “static” classification, a specification of the static firing sequence
A set of locations in the code which forced the classifier's analysis engine to make a given classification decision

The classification is based on the sequence of actions, which an actor might fire. An actor is classified as “static” if the token rates can be determined beforehand and “dynamic” otherwise. In particular, an actor whose token rates depend on the inputs it receives falls into the “dynamic” class. Classification is conservative in the sense that unless a static firing sequence can be found, the actor is assumed to be “dynamic”. Any misclassification thus attributes the actor to a more general class than a perfect classifier would.

Actor classification also determines whether an actor is guaranteed to execute indefinitely or whether it may enter a state from which no further firings are possible (i.e., termination). Again, the results are conservative: possible termination is assumed unless it can be ruled out.

A firing sequence, ƒ=ƒ₁; ƒ₂; . . . is the (possibly infinite) sequence of actions, which is fired in a particular execution of an actor. For the purpose of static scheduling, all possible executions of the actor must be considered, but there is no need to distinguish actions that have identical token consumption and production rates. If the token rates of each firing ƒᵢ; i=1, 2, . . . is identical over all executions of the actor, then it is said that the actor has a static firing sequence. An actor receives a “static” classification if and only if the classifier finds such a sequence.

The static firing sequences, which are produced by the classifier, generally consist of an initial sequence, which is executed once, and/or a periodic sequence that is repeated indefinitely. In particular, a terminating “static” actor has an initial sequence only.

An actor works by repeatedly selecting the next action to execute. The action selection is based on the internal state of the actor, the availability of inputs and, possibly, the value of inputs.

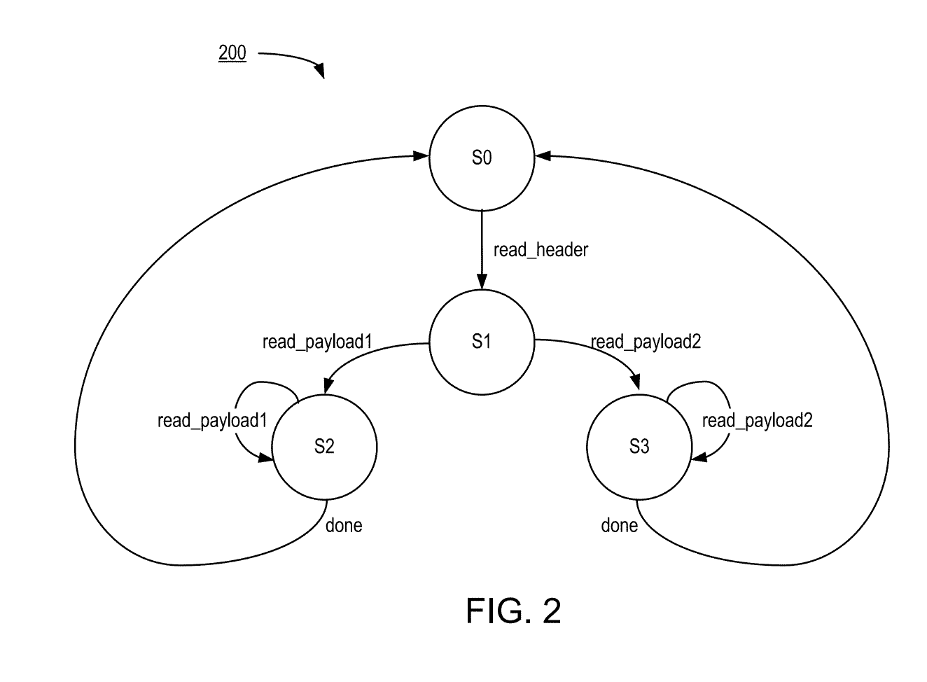

Action selection can be represented by a finite state machine in which transitions correspond to action firings. To illustrate this point, FIG. 2 shows a state machine 200 having states S2, S2, S3, and S4. The state machine 200 describes the selecting of actions (named “read_header”, “read_payload1”, “read_payload2”, and “done”). A state machine such as this can be specified explicitly in a dataflow programming language (e.g., the CAL programming language mentioned earlier). Alternatively, the state machine can be derived using, for example, abstract interpretation.

There is an initial state (e.g., in the example of FIG. 2, this is “S1”) and there may also be a state that corresponds to termination (i.e., a state from which there is no outgoing edge). (The example of FIG. 2 does not illustrate a terminal state.) The transitions that correspond to action firings have side-effects: mutation of the internal state and the consumption/production of inputs/outputs. The state machine may be constructed using analysis of the source code or it may be constructed directly using the Finite State Machine (FSM) syntax in a data flow language such as CAL.

After creating a finite state machine that represents the execution of the actor, the next step is an analysis to determine which class of dataflow programs the actor belongs. An actor can, for example, be classified into any of the following categories:
SDF (Synchronous Data Flow)—All firings consume and produce the same amount of tokens on each port.
CSDF (Cyclo Static Data Flow)—The actor has a cyclic behavior with respect to consumption and production of tokens on each port.
KPN (Kahn Process Network)—The actor semantics are consistent with blocking reads.
DN (Dynamic Dataflow)—The behavior of the actor is data dependent.

In many situations is preferable to have actors that belong to either of the first two categories because that allows for static analysis of memory usage and scheduling. The classification analysis is likely never to produce entirely accurate results, so a conservative approach must usually be taken (i.e., not all SDF actors may be identified and these may be wrongly classified as DN). The classification mechanisms used can be arbitrarily complex, using both abstract interpretation (such as is described in K.-E. Arzen, A. Nilsson, and C. von Platen, “D1e -Model Compiler,” published on Jan. 29, 2011 at http://www.control.lth.se/user/karlerik/Actors/M36/d1e-main.pdf) and/or constraint programming (such as is described in M. Wipliez, “Compilation infrastructure for dataflow programs, PhD thesis,” IETR/INSA, Tech. Rep, Dec. 9, 2010). However, many cases can be addressed with simpler approaches. For example, in order to answer the question whether or not the actor described by the FSM in FIG. 2 conforms to the SDF MoC, one only needs to look at the number of tokens consumed and produced at each action. For the actor to be SDF, all actions that may be fired must consume and produce exactly the same number. In case one action deviates from the others, this can be detected and the information identifying which action caused the actor to not be classified as SDF can be fed back to the software developer. Similarly, to answer whether the actor has a cyclic behavior, one needs to understand how the selection between actions “read payload1” and “read payload2” occurs (now assuming that they consume/produce different amounts of tokens). If the selection is based on the state, then abstract interpretation is used to further understand the behavior. However, if the selection is completely data dependent, then it can be concluded that this actor cannot be CSDF, and this information is fed back to the software developer together with information pointing to the firing conditions for actions “read payload1” and “read payload2” and stating that the selection is data dependent.

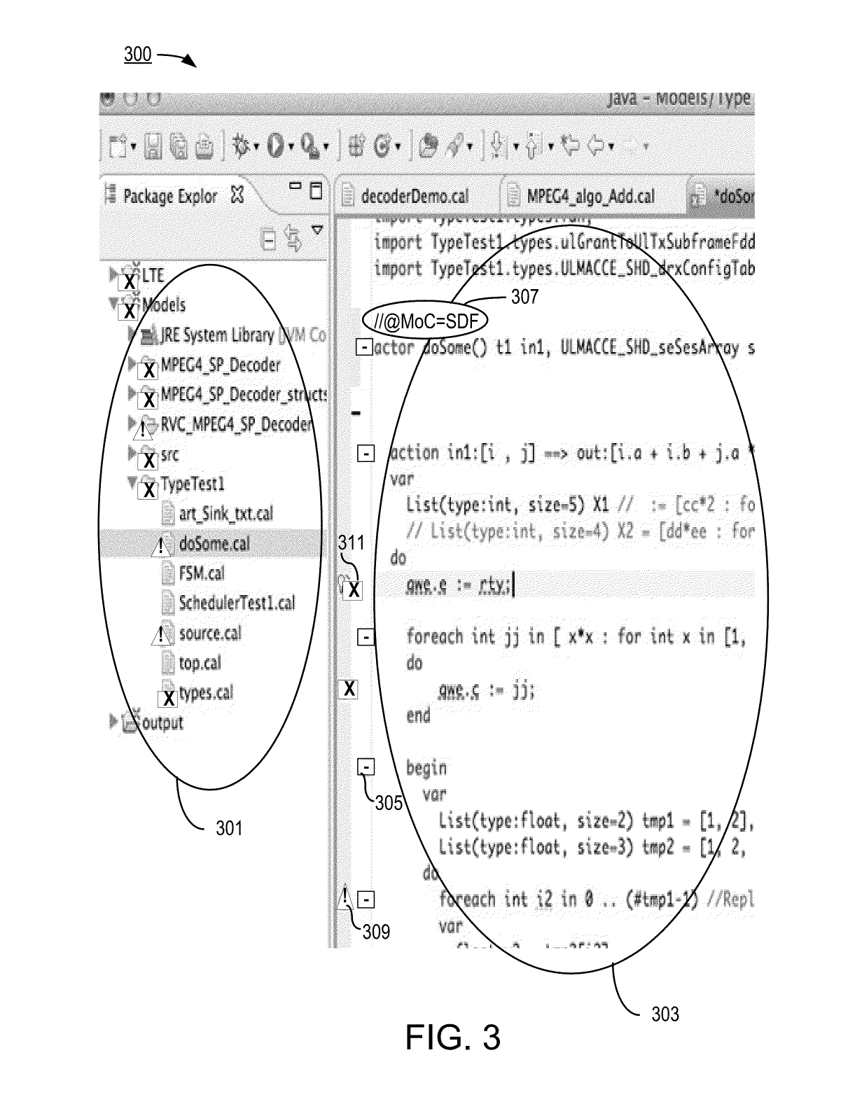

As explained above, the development tool MoC classification-related information that is derived from an analysis of dataflow program source code is, in accordance with aspects of embodiments consistent with the invention, supplied to the software developer. This information can be supplied in any of a number of forms. In one class of embodiments, this informational feedback is provided to the user by means of a development tool graphical user interface (GUI). FIG. 3 illustrates an example of one such GUI 300 created by incorporating an MoC analyzer into the Eclipse Integrated Development Environment (IDE). The interested reader is referred to http://www.eclipse.org/ for more information about the Eclipse IDE.

The exemplary GUI 300 includes controls by which the user is able to perform standard operations such as opening, closing, saving, and navigating through files representing various software package components. An explore area 301 of the GUI shows a hierarchical display of software package components in which their relation to one another can be perceived. By navigating through the software package components in the explore area 301, the source code in any of the software packages can be displayed and navigated in a source code area 301 of the GUI 300. (It will be appreciated that for purposes of illustration, source code text is schematically depicted in the source code area 301, but it is not intended that the depicted source code represent any code in particular.) The dataflow program development tool user can expand (to view more) or contract (to view less) portions of source code by clicking on boxes that include either a plus (“+”) sign or a minus (“−”) sign, respectively. In the example of FIG. 3, the exemplary source code portions are already expanded, so the user is presented only with options to contract portions of source, as indicated by the several boxes with minus signs in them. (Box 305 is one illustration of this control feature.)

Of particular relevance in this example are the means by which the software developer informs the system of the target (i.e., intended) MoC to which the source code is intended to conform, and also the informational feedback that is provided to the user, indicating the development tool's conclusions with respect to not only whether source code analysis indicated MoC compliance, but also wither respect to what source code portions are the reasons for these conclusions.

Looking first at the means by which the software developer informs the system of the target MoC, in this exemplary embodiment this is accomplished by the software developer incorporating target MoC indicators into the source code. In the illustrated example, one target MoC indicator 307 is included, this being a line of code reading “//@MoC=SDF”. The double slash (“//”) at the beginning of the line prevents any interpreter, compiler, assembler, or other standard dataflow program development component from interpreting this as a line of source code. The special text “@MoC=” is a keyword that informs the MoC analyzer (incorporated into the dataflow program development tool) that this line of code indicates a target MoC with which the following source code is intended to comply. The particular types of target MoC's (e.g., SDF, CSDF, KPN, DN) are then spelled out as text following the equal sign (in the example of FIG. 3, the target MoC is stated as “SDF”, but this is not a requirement) and the analyzer uses this as the basis for its analysis.

Results of the MoC analysis are also presented to the user of the development tool. In this example, a graphic symbol comprising an exclamation mark (“!”) contained within a triangle (e.g., see the exemplary warning symbol 309) are placed in-line with lines of source code to alert the user that the corresponding line of source code is one basis for the MoC analyzer to conclude that the source code is not in conformance with the target MoC. The user can utilize this information to determine how best to modify the source code in a way that will achieve the desired compliance. Another graphic symbol, in this instance an ex (“X”) contained within a square (e.g., see the exemplary non-compliance symbol 311) are placed in-line with lines of source code to indicate that an error has occurred, possibly resulting from a violation of the restrictions imposed by the programmer's choice of target MoC.

In another aspect of embodiments consistent with the invention, the various graphic symbols created by the MoC analyzer are also utilized within the explore area 301 so that the user can easily identify which software package components have non-conformance problems, and also what types of problems.

It will be appreciated that the variously depicted graphic symbols (e.g., exclamation mark within a triangle, an ex within a circle or square) are non-limiting examples meant merely for the purpose of illustration and that any graphic symbol or text could be substituted for these examples without altering the concepts illustrated by this exemplary embodiment.

It will further be appreciated that instead of placing the target MoC indicator 307 into the source code itself, alternative embodiments can involve a control feature built into the dataflow program development tool, such as but not limited to a drop down window in the GUI 300 that enables the user to select a desired target MoC. In yet another alternative embodiments, the target MoC can be specified by the user in the project settings portion of the dataflow program development tool.

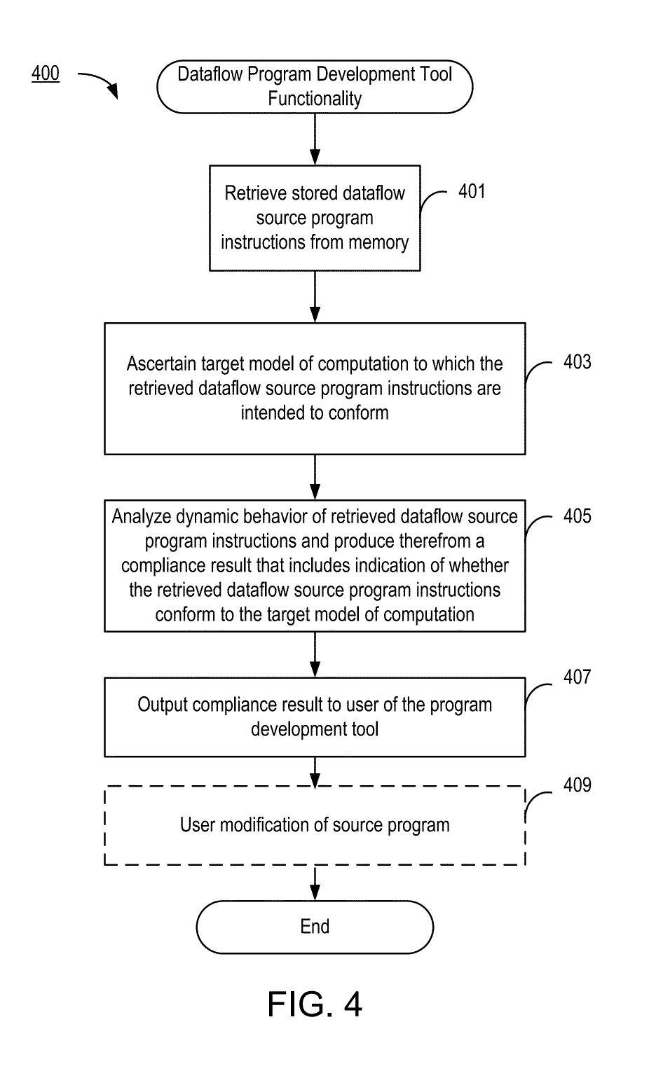

To further illustrate aspects of embodiments consistent with exemplary embodiments of the invention, FIG. 4 is, in one respect, a flow chart of steps/processes performed by a dataflow program development tool in accordance with some but not necessarily all exemplary embodiments of the invention. In another respect, FIG. 4 can be considered to depict exemplary means 400 comprising the various illustrated circuitry (e.g., hard-wired and/or suitably programmed processor) configured to perform the described functions.

In this exemplary embodiment, it is assumed at the outset that the dataflow source program to be analyzed is stored in a non-transitory processor-readable storage medium. Accordingly, an initial step includes retrieving stored dataflow source program instructions from a memory (step 401).

The development tool also ascertains a target model of computation to which the retrieved dataflow source program instructions are intended to conform (step 403). In some but not necessarily all embodiments, this is accomplished by retrieving a portion of the stored dataflow source program instructions that includes an indicator of the target model of computation. The indicator can be, for example, a keyword embedded in a comment line of the dataflow source program instructions. In some other embodiments, the dataflow program development tool provides other mechanisms by which the user can input a desired target MoC. At least in these latter embodiments, ascertaining the target model can be performed either before or after retrieving the stored dataflow source program instructions.

The dataflow program development tool then analyzes a dynamic behavior of the retrieved dataflow source program instructions and producing, from this analysis, a compliance result that includes an indication of whether the retrieved dataflow source program instructions conform to the target model of computation (step 405).

The compliance result is then output to a user of the program development tool (step 407). This can be, for example, in the form of one or more graphic indicators of noncompliance that are displayed in-line with one or more displayed dataflow source program instructions, such as was illustrated in the exemplary GUI 300 of FIG. 3.

In another aspect of some but not necessarily all embodiments consistent with the invention, the dataflow program development tool also operates as a source code development tool (e.g., including source code editing functionality). In such cases, the user can use the dataflow program development tool's interface (e.g., the GUI 300) to modify one or more lines of the dataflow source program instructions (step 409—indicated in dashed lines to represent that such modification is an optional step). This is advantageously performed based on any graphic indicators of noncompliance that were presented to the user. Such graphic indicators of noncompliance can point out to the user which line or lines of source program instructions (or one or more program structures implicated by the line or lines of flagged source program instructions) should be modified. This helps speed the software development process and improves the quality of the generated program.

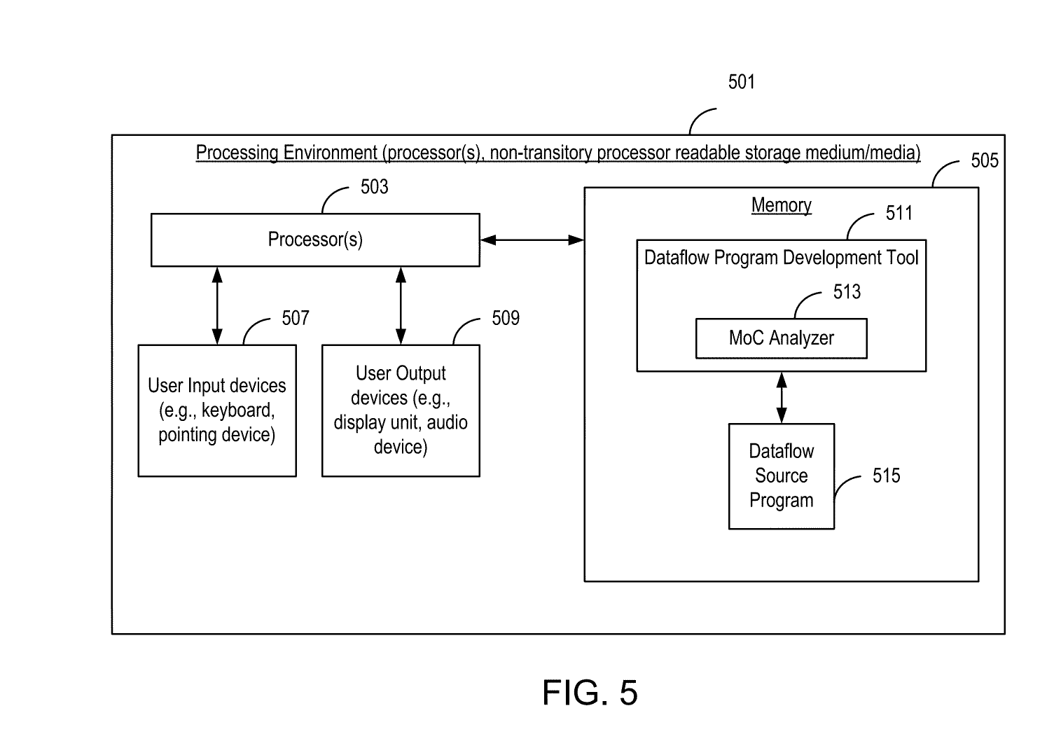

FIG. 5 is a block diagram showing an overall exemplary embodiment of a processing environment that includes a dataflow program development tool that provides informational feedback to the user with respect to source code compliance with a target model of computation.

A processing environment 501 is provided that comprises one or more processors 503 coupled to processor-readable media (e.g., one or more electronic, magnetic, or optical memory devices 505—hereinafter generically referred to as “memory 505”). The user is able to interact with and control the processor(s) 503 by means of user input devices 507 (e.g., keyboard, and some sort of pointing device) and user output devices 509 (e.g., display unit, audio device).

The processor(s) 503 are configured to access the memory 505 to retrieve and execute program instructions that constitute a dataflow program development tool 511. The dataflow program development tool 511 includes an MoC analyzer 513 by which it can carry out processes such as those described with respect to FIG. 4. Among these are processes that cause the processor(s) 503 to retrieve and analyze dataflow program source code instructions 515 with respect to whether they define processes that conform to a target model of computation. The dataflow program source code instructions 515 are here depicted as being stored in the memory 505 along with the dataflow program development tool 511, although this is not an essential aspect of the invention. The dataflow program development tool 511 also causes the processor(s) 503 to present informational feedback, based on its analysis results, to the user by means of one or more of the user output devices 509. Other aspects of the dataflow program development tool 511 enable a user (via the user input and output devices 507, 509) to modify portions of the dataflow program source code instructions 515 in order to, for example and without limitation, adapt the existing program, based on information feedback supplied by the dataflow program development tool 511, into a form that will conform to the target model of computation.

Embodiments that are consistent with the various aspects described above greatly simplify the efficient implementation of dataflow algorithms. They facilitate improved quality of dataflow programs, and increase programmer productivity.

The invention has been described with reference to particular embodiments. However, it will be readily apparent to those skilled in the art that it is possible to embody the invention in specific forms other than those of the embodiment described above. The described embodiments are merely illustrative and should not be considered restrictive in any way. The scope of the invention is given by the appended claims, rather than the preceding description, and all variations and equivalents which fall within the range of the claims are intended to be embraced therein.

What is claimed is:

1. A method of processing a dataflow source program by a program development tool, the method comprising:
the program development tool performing:
retrieving stored dataflow source program instructions from a memory;
ascertaining a target model of computation to which the retrieved dataflow source program instructions are intended to conform;
analyzing a dynamic behavior of the retrieved dataflow source program instructions and producing therefrom a compliance result that includes an indication of whether the retrieved dataflow source program instructions conform to the target model of computation; and
outputting the compliance result to a user of the program development tool.

2. The method of claim 1, wherein the compliance result includes an indication of which dataflow source program instruction or instructions is/are the reason for a failure of the retrieved dataflow source program instructions to conform to the target model of computation.

3. The method of claim 1, comprising:
displaying one or more of the retrieved dataflow source program instructions to the user of the program development tool,
wherein outputting the compliance result to the user of the program development tool comprises displaying one or more graphic indicators of noncompliance in-line with one or more displayed dataflow source program instructions.

4. The method of claim 1, comprising modifying the retrieved dataflow source program instructions based on information supplied to the program development tool by the user of the program development tool.

5. The method of claim 1, wherein ascertaining the target model of computation to which the retrieved dataflow source program instructions are intended to conform comprises:
retrieving a portion of the stored dataflow source program instructions that includes an indicator of the target model of computation.

6. The method of claim 5, wherein the indicator of the target model of computation includes a keyword embedded in a comment line of the dataflow source program instructions.

7. The method of claim 1, wherein ascertaining the target model of computation to which the retrieved dataflow source program instructions are intended to conform comprises:
using an interactive program development tool interface to receive an indicator of the target model of computation from the user of the program development tool.

8. The method of claim 1, wherein ascertaining the target model of computation to which the retrieved dataflow source program instructions are intended to conform comprises:
receiving an indicator of the target model of computation from a stored project settings portion of the dataflow program development tool.

9. A program development tool apparatus for processing a dataflow source program, the program development tool apparatus comprising:
circuitry configured to retrieve stored dataflow source program instructions from a memory;
circuitry configured to ascertain a target model of computation to which the retrieved dataflow source program instructions are intended to conform;
circuitry configured to analyze a dynamic behavior of the retrieved dataflow source program instructions and to produce therefrom a compliance result that includes an indication of whether the retrieved dataflow source program instructions conform to the target model of computation; and
circuitry configured to output the compliance result to a user of the program development tool apparatus.

10. The program development tool apparatus of claim 9, wherein the compliance result includes an indication of which dataflow source program instruction or instructions is/are the reason for a failure of the retrieved dataflow source program instructions to conform to the target model of computation.

11. The program development tool apparatus of claim 9, comprising:
display circuitry configured to display one or more of the retrieved dataflow source program instructions to the user of the program development tool,
wherein the circuitry configured to output the compliance result to the user of the program development tool comprises circuitry configured to display one or more graphic indicators of noncompliance in-line with one or more displayed dataflow source program instructions.

12. The program development tool apparatus of claim 9, comprising circuitry configured to modify the retrieved dataflow source program instructions based on information supplied to the program development tool apparatus by the user of the program development tool apparatus.

13. The program development tool apparatus of claim 9, wherein the circuitry configured to ascertain the target model of computation to which the retrieved dataflow source program instructions are intended to conform comprises:
circuitry configured to retrieve a portion of the stored dataflow source program instructions that includes an indicator of the target model of computation.

14. The program development tool apparatus of claim 13, wherein the indicator of the target model of computation includes a keyword embedded in a comment line of the dataflow source program instructions.

15. The program development tool apparatus of claim 9, wherein the circuitry configured to ascertain the target model of computation to which the retrieved dataflow source program instructions are intended to conform comprises:
an interactive program development tool interface configured to receive an indicator of the target model of computation from the user of the program development tool.

16. The program development tool apparatus of claim 9, wherein the circuitry configured to ascertain the target model of computation to which the retrieved dataflow source program instructions are intended to conform comprises:
circuitry configured to receive an indicator of the target model of computation from a stored project settings portion of the dataflow program development tool apparatus.
